(19) United States
(12) Patent Application Publication
(10) Pub. No.: US 2005/0133746 A1
(43) Pub. Date: Jun. 23, 2005

(54) High speed scanning device and film writer for use with radiographic media

(75) Inventors: Roger S. Kerr, Brockport, NY (US); Seung-Ho Baek, Pittsford, NY (US); Thomas A. Mackin, Hamlin, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/744,538

(22) Filed: Dec. 22, 2003

(51) Int. Cl. G01D 9/42; G01T 1/105

(52) U.S. Cl. 250/584; 346/33 B; 346/107.1

(57) ABSTRACT

A high speed scanning device and film writer for use with radiographic media with a first scanning stage (10) adapted for movement in a first and second direction (11, 13) along a first axis (14); a second scanning stage (12) disposed opposite the first scanning stage for movement in a third and fourth direction (15, 16) along a second axis (17); a scanning module (18) mounted on the first scanning stage; a film writer (19) disposed on the second scanning stage; a control processing unit adapted to combine the scanned images from each scanning module; and a continuous drive cable (20) with a first pin (22) for sequentially moving the scanning stage from a first to a second position; a second pin (30) for moving the balancing stage simultaneously with the scanning stage initially in a third to the fourth position (29, 31); wherein the first pin moves the balancing stage from the fourth to the third position while second pin moves the scanning stage from the second to the first position (27, 25).

### CROSS REFERENCE TO RELATED APPLICATIONS

Reference is made to commonly-assigned copending U.S. patent application Ser. No.______ (Attorney Docket No. 86153/NAB), filed herewith, entitled A HIGH SPEED SCANNING DEVICE FOR USE WITH RADIOGRAPHIC MEDIA, by Kerr et al.; and U.S. patent application Ser. No. ______ (Attorney Docket No. 86154/NAB), filed herewith, entitled A HIGH SPEED COUNTERBALANCED TRANSLATION DEVICE FOR USE WITH RADIOGRAPHIC MEDIA, by Kerr et al., the disclosures of which are incorporated herein.

### FIELD OF THE INVENTION

This invention relates in general to radiography and in particular to scanning a phosphor plate and simultaneously writing to radiography film.

### BACKGROUND OF THE INVENTION

In a photo-stimulatable phosphor imaging system, as described in U.S. Pat. No. RE 31,847, a photo-stimulatable phosphor sheet is exposed to an image wise pattern of short wavelength radiation, such as x-radiation, to record a latent image pattern in the photo-stimulatable phosphor sheet. The latent image is read out by stimulating the phosphor with a relatively long wavelength stimulating radiation such as red or infrared light. Upon stimulation, the photo-stimulatable phosphor releases emitted radiation of an intermediate wavelength such as blue or violet light in proportion to the quantity of short wavelength radiation that was received. To produce a signal useful in electronic image processing, the photo-stimulatable phosphor sheet is scanned in a raster pattern by a beam of light to produced emitted radiation, which is sensed by a photo-detector such as a photo-multiplier tube to produce the electronic image signal. The signal is then transmitted to a separate device, a film writer, which reproduces the scanned image.

This system is somewhat cumbersome since it involves a separate scanning unit and film writing unit. It would be desirable to combine the film writing unit and the scanning unit on a common drive to save cost, space, and time.

A need has existed for a method to scan radiographic images from radiographic media and then rewrite the scanned image using a film writer that is fast, stable and has a continuous drive system so that the scanning rates are improved and the image quality improves.

### SUMMARY OF THE INVENTION

An embodiment of the present invention is a high speed scanning device and film writer for use with radiographic media. The device includes a first scanning stage adapted for movement in a first and second direction along a first axis and a second scanning stage disposed opposite the first scanning stage adapted for movement in a third and fourth direction along a second axis. The translation device also includes a scanning module mounted on the first scanning stage and a film writer disposed on the second scanning stage. The device also includes a control processing unit to receive scanned images from the scanning module, to convert the scanned images to a digital content, and to transmit the digital content to the film writer. The device also has a continuous drive cable engaging a drive pulley with a drive motor for rotating the drive pulley.

The continuous drive cable on the translation device includes a first pin for sequentially moving the scanning stage in from a first to a second position by engaging the first scanning stage slot located in the scanning stage. A second pin in the continuous drive cable moves the balancing stage simultaneously with the scanning stage initially in a third position to the fourth position by engaging the balancing stage slot. In sequence, the first pin moves the balancing stage from the fourth position to the third position while second pin moves the scanning stage from the second position to the first position.

An embodiment of the present invention is a single-stage high speed scanning and film writer device for use with radiographic media.

An embodiment of the present invention is a method for scanning and writing diagnostic film is comprised by placing a radiographic plate on adjacent a scanning module and inserting a diagnostic film adjacent to a film writer. The method continues by scanning the radiographic plate with a scanning module in a first direction; converting the scanned image to a digital signal; transmitting the digital signal to the film writer; and writing the signal on the diagnostic film. The method continues by repeating these steps until repeating the steps until the image is completely scanned.

The invention and its objects and advantages will become more apparent in the detailed description of the preferred embodiment presented below.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with accompanying drawings.

FIG. 1 is a schematic of the invention;

FIG. 2 is a schematic of the invention in the first and third positions;

FIG. 3 is a schematic of the invention in the second and fourth positions;

FIG. 4 is a schematic of the invention in the first and third positions;

FIG. 5 is a schematic of the invention second and fourth positions;

FIG. 6 depicts a side view of the scanning module;

FIG. 7 depicts a side view of the scanning module with a collimator lens;

FIG. 8 is a schematic of the system; and

FIG. 9 is a schematic of the method of the invention.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

The invention was designed for creating higher image quality in scanned radiographic images while providing for a high speed, ultra stable scanning and writing device. In a preferred embodiment, the radiographic images are a phosphorous plate. The invention can include a control processing unit to combine the scanned images from each scanning module and can also include a film writer.

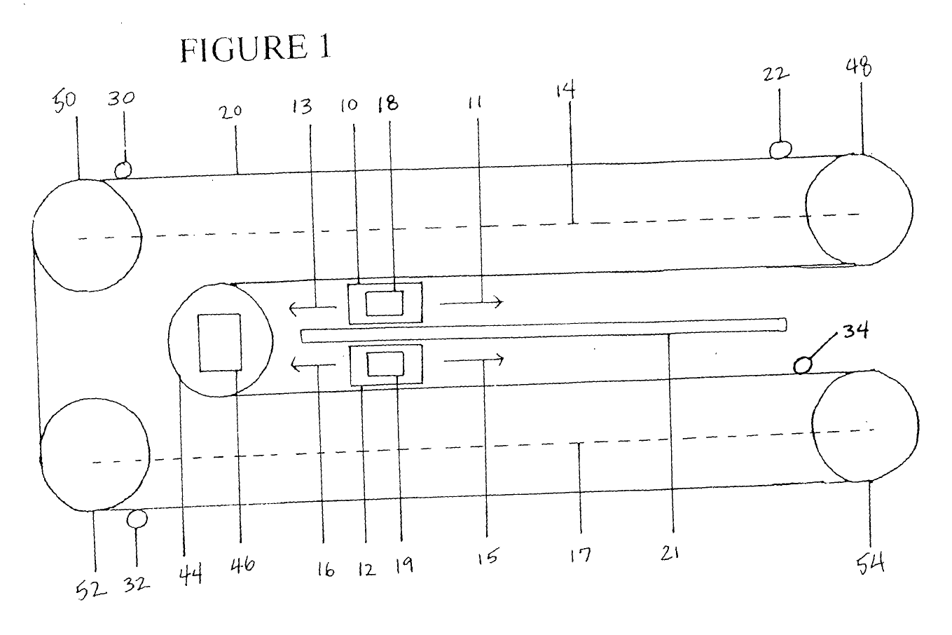

Referring now to FIGS. 1 through 3, a first scanning stage 10 is adapted for movement in a first direction 11 and a second direction 13 along a first axis 14. As a second scanning stage 12 is disposed opposite the scanning stage in a balanced relationship, so that the movement of the second scanning stage balances the weight of the scanning stage.

The second scanning stage moves in a third direction 15 and a fourth direction 16 along a second axis 17. It should be noted in the preferred embodiment, the first axis is parallel to the second axis.

A scanning module 18 is mounted to the scanning stage for scanning radiographic media 21 that is placed on the scanning stage. The scanner sends a beam of light, exciting the image, to the radiographic plate or sheet, and then the scanner collects the light and sends the collected light to a processor for storage.

A film writer 19 is mounted to the second scanning stage to provide a balance. An example of a film writer 19 is a Kodak Drive U Imager 850 available from Eastman Kodak Company of Rochester, N.Y.

Preferably the second scanning module is mounted so as to provide a stable device with good balance. Preferably, the second scanning module is mounted so as to provide a counterbalance as well s the additional scanning advantage in the device. In a preferred embodiment, the second scanning module is mounted beneath the radiographic media and the first scanning module is mounted above the radiographic media.

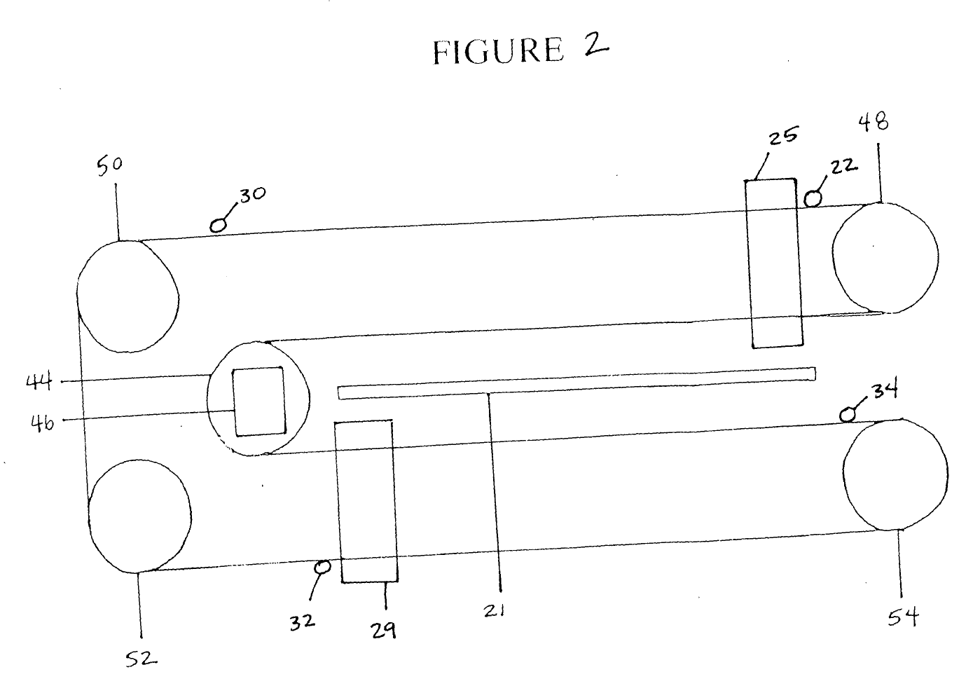

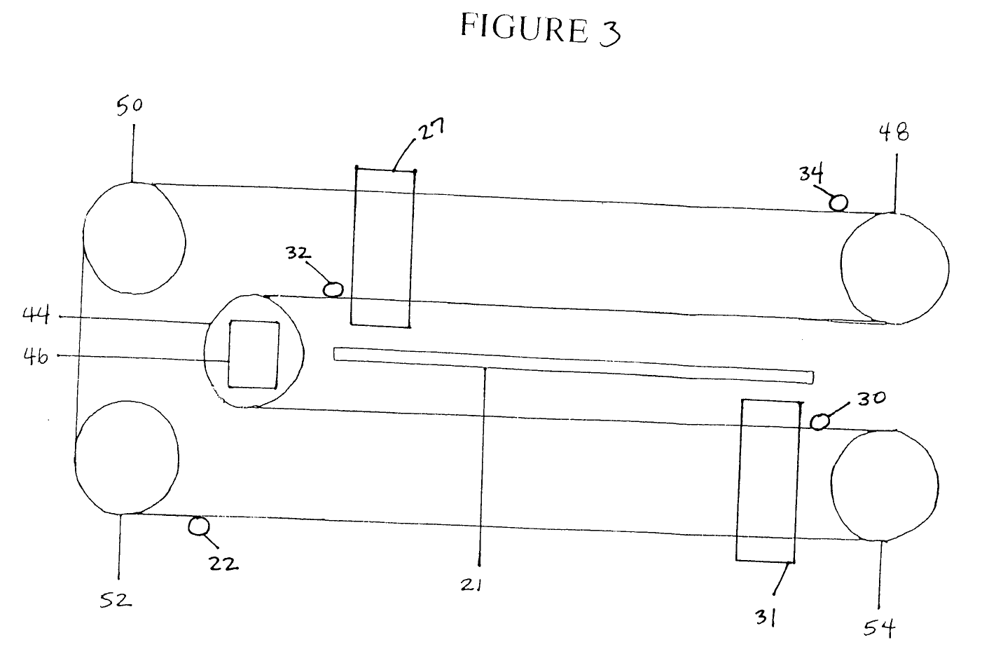

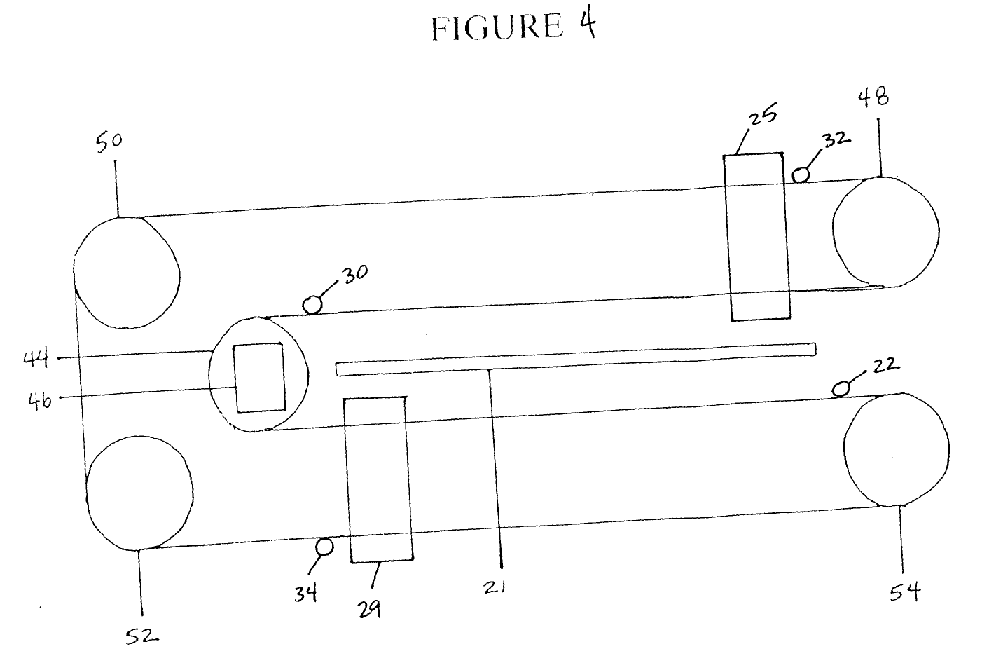

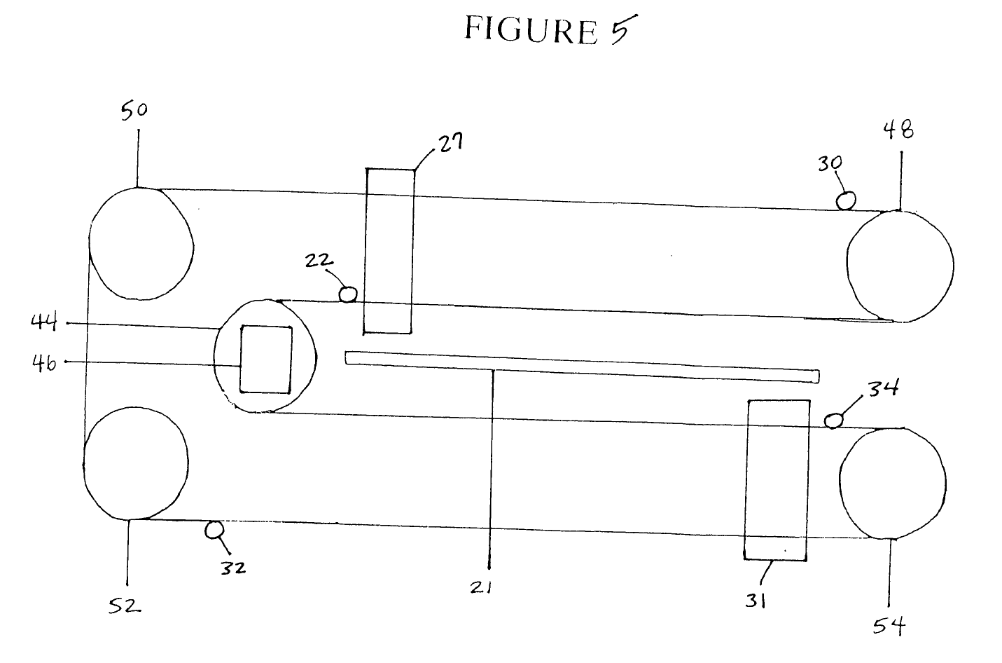

FIG. 2 and FIG. 4 depict the first and second scanning stages 10 and 12 at the first and third positions 25 and 29, respectively. FIG. 3 and FIG. 5 depicts the first and second scanning stages 10 and 12 at the second and fourth positions 27 and 31, respectively. FIGS. 2 through 5 depict examples of the possible positions of the four pins 22, 30, 32, and 34 in moving the scanning stage 10 and 12.

The scanning module has a housing and a reflective center chamber, such as a mirrored container, in the housing that can have an elliptical design. The module contains a laser that transmits a beam of light onto a radiographic plate, such as a phosphorous plate to create an image with a high sensitivity, around 0.7 mj/cm2, an image quality as good as 300 dpi, and a rate of productivity that is preferably between 80 plates per hour and 120 plates per hour. The module can have a small compact design, such as with a diameter of 15 mm to 23 mm, preferably 20 mm, and a length that creates as an ellipsoid with a surface calculated from the following formula:
(x²/9.6437²)+(y²/9.6437²)+((z-11)²/17²)=1
The scanning module is adapted for emitting light to and collecting light from a photo-stimulatable radiographic sheet, such a phosphorous sheet or other similar radiographic sheet, filtering that light and then converting the light into a digital signal.

The integrated scanning module can be used for line scanning or swath scanning. To operate the module, a laser disposed in a housing emits a beam of light onto the graphic sheet. In the most preferred embodiment, one laser is used per module. It is contemplated that multiple housing can be connected together, in parallel to form a swath for scanning over multiple spots.

The beam, which is preferably from a Hitachi single mode 635 nm, 35 mW laser or alternatively a multi mode 635 nm, 100 mW laser could be used. The beam is directed at discrete spots on the radiographic plate that already contains latent images.

The beam stimulates the radiographic plate to produce light that is collected by the module, in a preferably cylindrical, ellipsoid shaped mirrored container. A minor amount of reflected light may be collected as well.

A blue filter is used to selectively pass only the light from the radiographic image to a light detector that is preferably a PMT device, (at least one photo-multiplier tube) or a solid state photodiode. The filter is of the type Hoya 390 or B 410 from Tokyo, Japan or alternatively Schott BG-1 or BG 3 filter available from Schott of Mainz, Germany.

The light detector, such as a PMT made by Hamamatsu or a photomultiplier type R7400U available from Japan, receives the filtered light and generates a signal. The signal is transmitted to an analog to digital converter is usable to provide a digital signal. The digital signal is then stored as an image frame in a control processor, such as a computer like as a PC, MAC.

Next, the digital image can be processed depending on the needs of the user. For example, the digital image could then be printed on black and white X-Ray film.

The scanning module is contemplated for use as an input scanner.

Multiple modules can be used to scan a radiographic plate. Alternatively, only one module can be used to scan for individual spots on a plate. Both individual and multiple modules can be used to swath scan, diagonally, multiple spots on the plate.

Further, individual modules can be placed on a rotating disc over a stationary plate to achieve faster scanning of an image than with the line scanning method. The use of the modules on a rotating disc provides a more smooth, more even scanning of the image.

Alternatively, the plate can be rotated and the modules held stationary to achieve a smooth scan of the image.

The high speed counterbalanced scanning device also includes a control processing unit adapted to combine the scanned images from each scanning module. The control processing unit 58 is depicted in the FIG. 4.

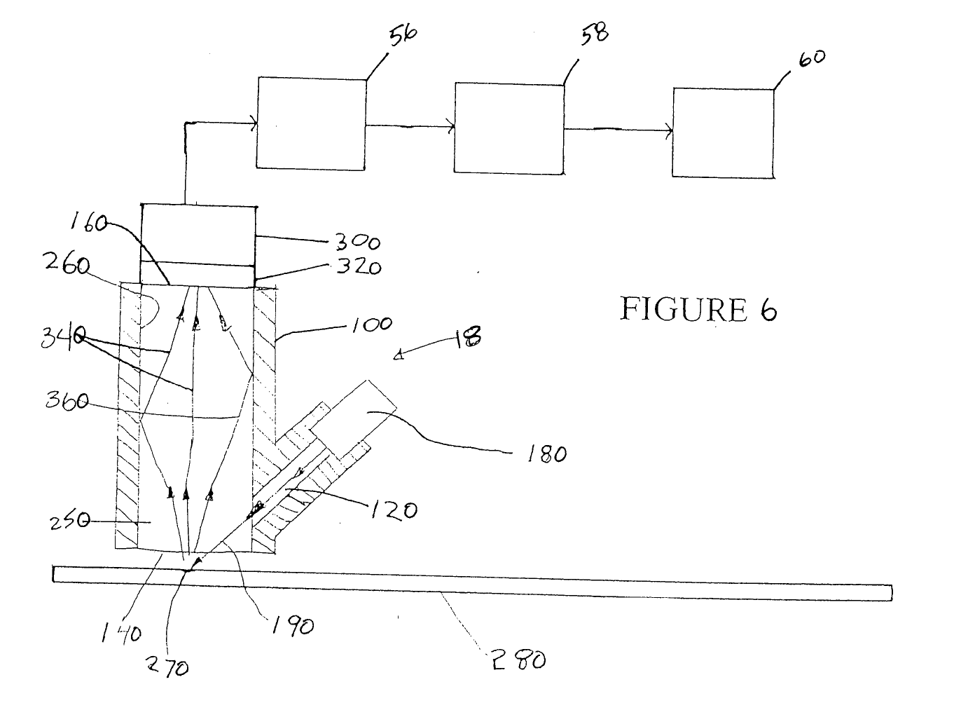

As shown in FIG. 6, the high speed counterbalanced scanning device also includes an output device 60. The scanned image from the device is sent to an analog to digital converter 56 that transmits the image to a control processing unit 58. The control processing unit 58, in turn, communicates the image to an output device 60. The output device 60 writes the image on media.

A two pin method can drive the two stages. The invention contemplates that other configurations can also be used to drive the two stages. The figures depict the embodiment of a four-pin method driving the two stages.

In particular, a drive cable 20, which can be a belt or a cable has a first pin 22 for simultaneously engaging with a scanning stage slot disposed in the scanning stage. The first pin 22 engaging the scanning stage slot is pulled by the drive cable and the first pin then moves the scanning stage from a first position 25 as shown in to a second position 27.

The drive cable 20 has a second pin 30 for simultaneously engaging with a second scanning stage slot while the first pin 22 is engaged with the first scanning stage slot. The first pin as connected to the drive cable, moves the first scanning stage in a direction opposite from the second pin as connected to the drive cable engaging the second scanning stage slot from a third position 29 to a fourth position 31.

The drive cable then can engage the second pin 30 with the second scanning stage via the second scanning stage slot and a third pin 32 engages the first scanning stage slot in the first scanning stage. The second pin 30 then moves the second scanning stage in a direction reverse from the fourth position 31 to the third position 29. The second pin moves the first scanning stage in a direction reverse direction from the second position to the first position. In this second movement, third pin and second pin drive the two stages simultaneously.

The drive cable 20 has a fourth pin 34 for engaging the second scanning stage slot and moving the second scanning stage from the third position 29 to the fourth position 31. Simultaneously with the movement of the second scanning stage using the fourth pin, the third pin engages the scanning stage slot and moves the scanning stage from the first position 25 to the second position 27.

In the fourth cycle, the drive cable has the first pin engaging the scanning stage slot and the fourth pin engages the second scanning stage. The first pin moves the scanning stage from second position to the first position and the fourth pin moves the second scanning stage from the fourth position to the third position. The cycle then repeats itself.

The effect of these pin engagements in the stage slots using the drive cable is to achieve a smooth second scanning continuous motion of one stage relative to the other stage while providing continuous smooth scanning and writing.

A drive pulley 44 connects to a drive motor 46 for rotating the drive pulley and thereby moving the drive cable with the pins. Four idler pulleys, 48, 50, 52, and 54 can be used with the drive cable 20 to support motion of the drive cable.

The invention contemplates a two pin embodiment of the invention described above wherein a high speed second scanning and writing device is used. In this embodiment, the device has a scanning stage having a scanning stage slot. The scanning stage is adapted for movement in a first direction and a second direction along a first axis. The device further has a second scanning stage having a second scanning stage slot. The second scanning stage is disposed opposite the scanning stage and is adapted for movement in a third direction and a fourth direction along a second axis. Two (or more) scanning modules can be used, at least one on the scanning stage.

A continuous drive cable is connected to and engages a drive pulley with drive motor for rotating the drive pulley. The cable, which can be a belt includes: a first pin for sequentially moving the scanning stage from a first position to a second position by engaging the scanning stage slot, and a second pin for moving the second scanning stage simultaneously with scanning stage from a third position to a fourth position by engaging the second scanning stage slot. Next, the first pin moves the second scanning stage from the fourth position to the third position while second pin moves the scanning stage from the second position to the first position.

This embodiment contemplates that the first axis is parallel to the second axis.

Both embodiments of the invention contemplate that the speed of the scanning module is between 10 inches per second and 80 inches per second, preferably 45 inches per second.

FIG. 6 is a depiction of a side view of a scanning module for use within the invention. The scanning module has a housing 100 with a channel 120 and the first and second openings 140 and 160. The scanning module also has cylindrical center chamber comprising a mirrored surface.

Within the housing 100, the scanning module has a laser 180 is oriented to generate a beam of stimulating electromagnetic radiation through the channel 120 into the first opening 140. The beam is preferably between 390 and 400 nm in size. The beam flows through the first opening 140 onto a stimulated spot 270 on a photo-stimulatable radiographic sheet 280. Light 340 is emitted from the stimulated spot and reflected light 360 bounces from the radiographic sheet 280 to enter the first opening 140. The emitted light 340 is then transmitted from the center channel out of the second opening 160 to the filter 320. The filter 320 only permits the light emitted from the stimulated spot 270 to pass to the light detector 300.

In a preferred embodiment, the center chamber 250 has the following dimensions: a length between 20 mm and 30 mm, preferably about 25 mm; a height between 20 mm and 25 mm, preferably about 20 mm; and a width between 20 mm and 25 mm, preferably about 20 mm.

Returning to FIG. 6, the light detector 300 is disposed in the second opening for receiving light from filter 320 also disposed at the second opening of the housing.

In the most preferred embodiment, the housing 100 can be a one-piece molded structure of a strong polycarbonate, a strong plastic, or a metal. A preferred overall dimension of the housing is a height of 54 mm, a width of 35 mm, and a length of 25 mm.

Alternatively, the housing 100 can be a two-piece construction. In the two-piece construction, the two halves can be joined by conventional attaching devices, such as a latch, welds, or one or more screws.

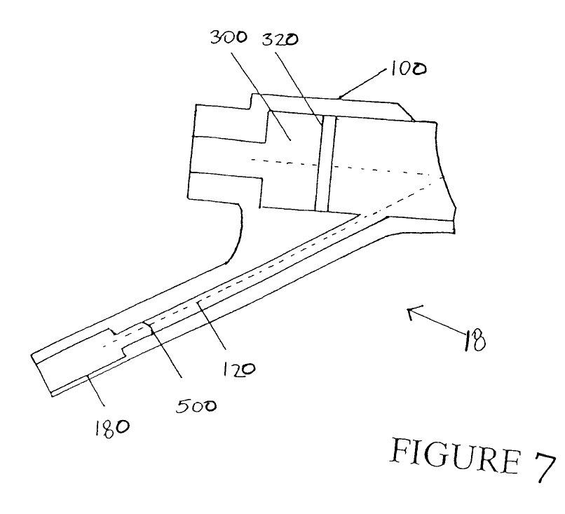

FIG. 7 depicts an embodiment of a scanning module 18 for emitting light to and collecting light from a photo-stimulatable radiographic sheet. The housing 100 includes a channel 120, a first opening 140, and a second opening 160. The laser 180 is disposed in the housing and generates a beam 190 of stimulating electromagnetic radiation through the channel 120 into the first opening 140. The beam 190 can in one embodiment pass through a collimator lens 500 prior to passing out of the channel 120.

Another embodiment is a system for emitting light to and collecting light from a photo-stimulatable radiographic sheet and then storing the image. The system includes a scanning module 18 for emitting light to and collects light from a photo-stimulatable radiographic sheet. The scanning module is the same as the module of FIG. 6.

In another embodiment, individual modules can be placed on a rotating disc over a stationary plate to achieve faster scanning of an image. The use of the modules on a rotating disc provides a smooth, even scanning of the image.

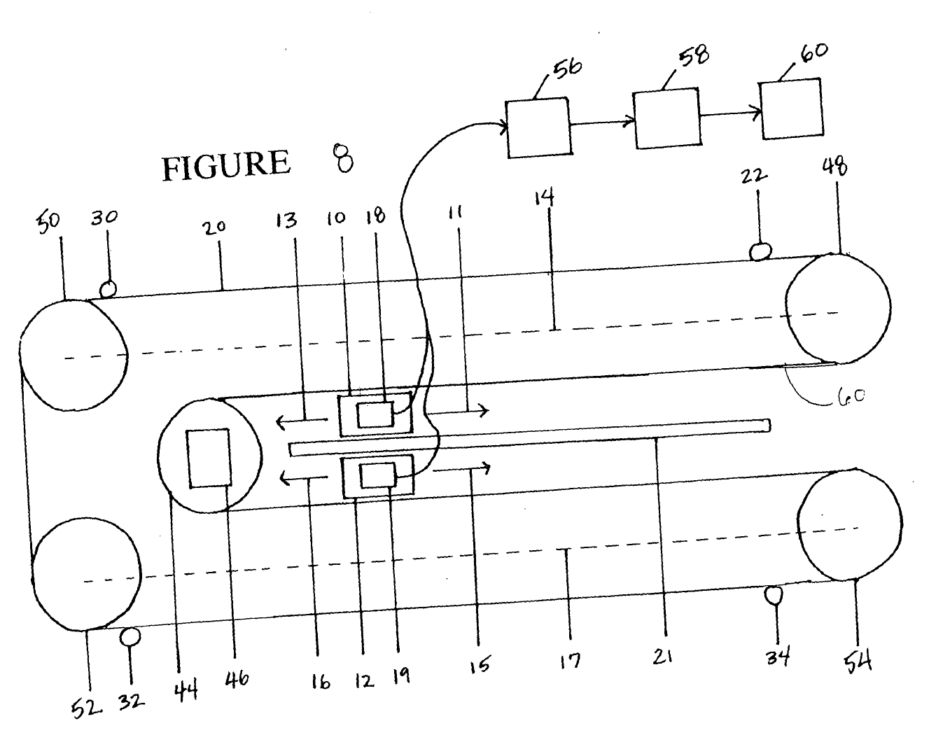

FIG. 8 illustrates one or more scanning modules that could be used in this system. Further the light detector 300 is shown in communication, such as by a wireless link, with an analog to digital converter 56 adapted to receive signal from the light detector 300.

A control processing unit 58 converts signal to signal from the analog to digital converter 56. The control processing unit 58 is capable of storing the now digital signal.

The system includes an output device 60 adapted to receive the digital signal from the control processing unit (CPU) 58. The CPU can be a computer, PC or MAC for compiling signals from one or more modules. The output device can be a film writer, printer, or display.

In another embodiment, the invention is a single-stage high speed scanning and film writer device for use with radiographic media. The embodiment has a scanning stage with a scanning stage slot adapted for movement in a first direction and a second direction along a first axis. A scanning module mounted is located on the scanning stage.

The embodiment also includes a film writer disposed on the scanning module. The film writer writes the scanned image onto a diagnostic film. A control processing unit in the device is adapted to receive scanned images from the scanning module, to convert the scanned images to a digital content, and to transmit the digital content to the film writer.

The single-stage high speed scanning and film writer device also includes a continuous drive cable engaging a drive pulley with drive motor for rotating the drive pulley. The drive system is made of a pin for moving the scanning stage from a first position to a second position by engaging the scanning stage slot, and then in reverse from the second position to the first position.

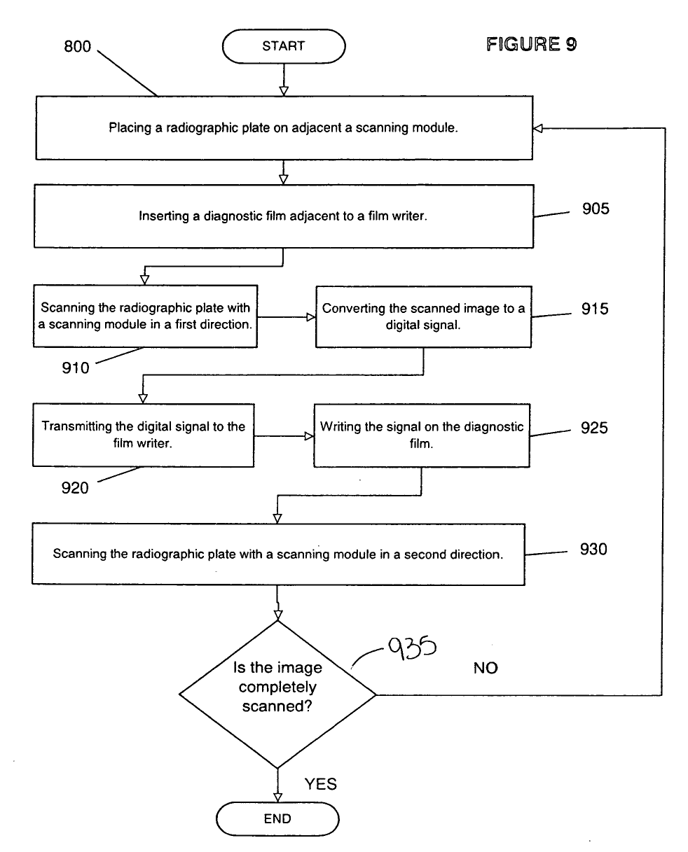

Another embodiment is a method for scanning and writing diagnostic film. As shown in FIG. 9, the method begins by placing a radiographic plate on adjacent a scanning module 800 and inserting a diagnostic film adjacent to a film writer 905 and scanning the radiographic plate with a scanning module in a first direction 910. The scanned image is next converted to a digital signal 915 and transmitted to the film writer 920. The signal is then written on the diagnostic film 925.

The method continues by scanning the radiographic plate with a scanning module in a second direction 930; converting the scanned image to the digital signal; and transmitting the digital signal to the film writer. The signal is written on the diagnostic film.

Continuing with FIG. 9, the method ends by repeating the steps of scanning, converting, transmitting, and writing until the image is completely scanned 935.

The invention has been described in detail with particular reference to certain preferred embodiments thereof, but it will be understood that variations and modifications can be effected within the scope of the invention.

### Parts List

10 first scanning stage
11 first direction
12 second scanning stage
13 second direction
14 first axis
15 third direction
16 fourth direction
17 second axis
19 film writer
20 drive cable
21 radiographic media
22 first pin
25 first position
27 second position
29 third position
30 second pin
31 fourth position
32 third pin
34 fourth pin
44 drive pulley
46 drive motor
48 first idler pulley
50 second idler pulley
52 third idler pulley
54 fourth idler pulley
56 analog to digital converter
58 control processing unit
60 input-output device
100 housing
120 channel
140 first opening
160 second opening
180 laser
190 beam
250 cylindrical center chamber
270 stimulated area or spot
280 radiographic sheet or media
300 light detector
320 filter
340 emitted light
360 reflected light
500 collimator lens
800 placing radiographic plate adjacent scanning module
905 inserting diagnostic film adjacent film writer
910 scanning radiographic plate with scanning module in first direction
915 scanned image converted to digital signal
920 digital signal transmitted to film writer
925 signal written on diagnostic film
930 scanning radiographic plate with scanning module in second direction
935 image completely scanned

1. A high speed scanning device and film writer for use with radiographic media comprising:
a) a first scanning stage comprising a first scanning stage slot, wherein the first scanning stage is adapted for movement in a first direction and a second direction along a first axis;
b) a second scanning stage comprising a second scanning stage slot, wherein the second scanning stage is disposed opposite the first scanning stage and is adapted for movement in a third direction and a fourth direction along a second axis;
c) a scanning module mounted on the first scanning stage;
d) wherein the film writer is disposed on the second scanning stage;
e) a control processing unit adapted to receive scanned images from the scanning module, to convert the scanned images to a digital content, and to transmit the digital content to the film writer; and
f) a continuous drive cable engaging a drive pulley with drive motor for rotating the drive pulley further comprising:
i) a first pin for sequentially moving the first scanning stage from a first position to a second position by engaging said first scanning stage slot;
ii) a second pin for moving the second scanning stage simultaneously with the first scanning stage initially in a third position to a fourth position by engaging said second scanning stage slot; and
iii) wherein, in sequence, the first pin then moves the second scanning stage from the fourth position to the third position while the second pin moves the first scanning stage from the second position to the first position.

2. The device of claim 1 wherein the drive cable is a belt.

3. The device of claim 1 wherein the first axis is parallel to the second axis.

4. The device of claim 1 wherein the film writer is a diagnostic imaging device.

5. The device of claim 1 wherein the speed of each the module is between 10 inches per second to 80 inches per second.

6. The device of claim 5 wherein the speed of the scanning module is 45 inches per second.

7. The device of claim 1 wherein the radiographic media is a phosphorous plate.

8. The device of claim 1 wherein the film writer acts a counterbalance to the scanning module to increase stability of the device.

9. A high speed scanning device and film writer for use with radiographic media comprising:
a) a scanning stage having a scanning stage slot, and wherein the scanning stage is adapted for movement in a first direction and a second direction along a first axis;
b) a scanning and writing stage having a scanning and writing stage slot, and wherein the scanning and writing stage is disposed opposite the scanning stage and is adapted for movement in a third direction and a fourth direction along a second axis;
c) a first scanning module mounted on the scanning stage;
d) a second scanning module mounted on the scanning and writing stage;
e) a film writer disposed on the scanning and writing stage that is complimentary in weight and size to the scanning module;
f) a control processing unit adapted to receive a scanned image from the scanning module, to convert the scanned image to a digital content, and to transmit the digital content to the film writer forming an image on diagnostic film; and
g) a continuous drive cable engaging a drive pulley with drive motor for rotating the drive pulley further comprising:
i) a first pin for sequentially moving the scanning stage in from a first position to a second position by engaging the scanning stage slot;
ii) a second pin for moving the scanning and writing stage simultaneously with scanning stage initially in a third position to the fourth position by engaging the scanning and writing stage slot; and
iii) wherein, in sequence, the first pin then moves the scanning and writing stage from the fourth position to the third position while second pin moves the scanning stage from the second position to the first position.

10. The device of claim 9 wherein the drive cable is a belt.

11. The device of claim 9 wherein the first axis is parallel to the second axis.

12. The device of claim 9 wherein the film writer is a diagnostic imaging device.

13. The device of claim 9 wherein the speed of each the module is between 10 inches per second to 80 inches per second.

14. The device of claim 13 wherein the speed of the scanning module is 45 inches per second.

15. The device of claim 9 wherein the radiographic media is a phosphorous plate.

16. A high speed scanning and film writer device for use with radiographic media comprising:
a) a scanning stage having a scanning stage slot, and wherein the scanning stage is adapted for movement in a first direction and a second direction along a first axis;
b) a scanning module mounted on the scanning stage;
c) a film writer disposed on the scanning module;
d) a control processing unit adapted to receive scanned images from the scanning module, to convert the scanned images to a digital content, and to transmit the digital content to the film writer, wherein the film writer writes the scanned image onto a diagnostic film; and
e) a continuous drive cable engaging a drive pulley with drive motor for rotating the drive pulley further comprising a pin for moving the scanning stage from a first position to a second position by engaging the scanning stage slot, and then in reverse from the second position to the first position.

17. The device of claim 16 wherein the drive cable is a belt.

18. The device of claim 16 wherein the first axis is parallel to the second axis.

19. The device of claim 16 wherein the film writer is a diagnostic imaging device.

20. The device of claim 16 wherein the speed of each the module is between 10 inches per second to 80 inches per second.

21. The device of claim 20 wherein the speed of the scanning module is 45 inches per second.

22. The device of claim 16 wherein the radiographic media is a phosphorous plate.

23. A method for scanning and writing diagnostic film comprising the steps of:
a) placing a radiographic plate on adjacent a scanning module;
b) inserting a diagnostic film adjacent to a film writer;
c) scanning the radiographic plate with a scanning module in a first direction;
d) converting the scanned image to a digital signal;
e) transmitting the digital signal to the film writer;
f) writing the signal on the diagnostic film;
g) scanning the radiographic plate with a scanning module in a second direction;
h) converting the scanned image to the digital signal;
i) transmitting the digital signal to the film writer;
j) writing the signal on the diagnostic film; and
k) repeating the steps until the image is completely scanned.
